(19) United States
(12) Patent Application Publication
(10) Pub. No.: US 2009/0292680 A1
(43) Pub. Date: Nov. 26, 2009

(54) Systems and Methods for Syndicating Content To, And Mining Content From, Internet-Based Forums

(76) Inventor: Sanjay Sabnani, Northridge, CA (US)

Correspondence Address: PATENTMETRIX, 14252 CULVER DR. BOX 914, IRVINE, CA, 92604, US

(21) Appl. No.: 12/470,601

(22) Filed: May 22, 2009

Related U.S. Application Data
(60) Provisional application No. 61/055,156, filed on May 22, 2008.

(51) Int. Cl. G06F 3/048; G06F 17/30

(52) U.S. Cl. 707/3; 715/809; 707/E17.108

(57) ABSTRACT

The present invention is directed to a system for mediating an electronic communication between a forum and a non-member of the forum. The system includes a server having programmatic instructions where execution of the programmatic instructions by a processor a) generates data representative of a GUI, where the GUI prompts a user to input a query, b) receives data representative of the query, c) parses data representative of the query and uses the parsed data to create a forum interface call, d) transmits the forum interface call to remotely located servers, where at least some of the servers hosts at least one forum, e) in response to the transmission of forum interface calls, receives responses responsive to the query, and f) generates data representative of another GUI, which provides a user electronic access to the responses.

### CROSS-REFERENCE

The present invention relies on U.S. Provisional Application No. 61/055,156, filed on May 22, 2008, which is herein incorporated by reference.

### FIELD OF THE INVENTION

The present invention relates generally to the field of online/Internet forums, and specifically to methods and systems for enabling users of a forum to syndicate content to, and mine content from, the forum. In particular, the present invention relates to systems and methods for enabling non-member users of a forum to syndicate content to, and mine content from, forums without compromising the character and community integrity of the forums.

### BACKGROUND OF THE INVENTION

Internet-based or “on-line” forums facilitate the exchange of information; users may communicate with others through successive electronic transmissions between respective computer systems. These online forums are a great source of knowledge that is generated as forum-members interact and socialize with each other. Forums are also useful platforms to post queries designed to tap into the expert potential of certain forum members. These forums also provide useful platforms to disseminate content, knowledge or information as the very nature of these forums ensures that the content reaches like-minded people or people who are interested in the subject matter and/or character of the forum.

However, the ability to tap into forum knowledge and/or share content is typically available only to registered forum-members. Thus, in order to query a particular forum, a user must register with each individual forum that he wishes to query or derive knowledge from. In other words, the usability of forums for syndicating queries and/or content thereto is generally not available to non-members or the general Internet populace. One of the key reasons for this is to ensure that the character and community integrity of the forums is not compromised by non-registered or anonymous, unverified users.

Therefore, what is needed is a system and method for disseminating forum knowledge and content throughout the Internet without compromising the integrity of the knowledge, content, and community of the forum.

Additionally, what is needed is a system and method for disseminating Internet forum knowledge and content by and between registered members and non-members alike without compromising the integrity of the knowledge, content, and community of the forum.

### SUMMARY OF THE INVENTION

In one embodiment, the present invention is directed to a system for mediating an electronic communication between a forum having members and a non-member of said forum, comprising a server having programmatic instructions wherein execution of said programmatic instructions by a processor a) generates data representative of a first GUI, said first GUI prompting a user of said computing device to input a query, b) receives data representative of said query, c) parses said data representative of said query and uses said parsed data to create a forum interface call, d) transmits said forum interface call to a plurality of remotely located servers through a network, wherein at least some of said servers hosts at least one forum, e) in response to said transmission of forum interface calls, receives responses responsive to said query, and d) generates data representative of a second GUI, said second GUI providing a user of said computing device electronic access to said responses.

Optionally, the interface call includes a plurality of fields and wherein at least one of said fields is a type, keyword, or profile field. The parsing of data representative of the query generates a plurality of keywords and wherein at least one of said keywords is input into a field of said interface call. The response responsive to said query includes a plurality of fields and wherein at least one of said fields identifies a network address where a query response is located. The response responsive to said query includes a plurality of fields and wherein said plurality of fields include at least one of a link to an identity of a respondent, a link to a respondent's response, or a parameter defining how queries may be inputted into, or extracted from, a forum. The system further comprises programmatic instructions wherein execution of said programmatic instructions by a processor generates data representative of a third GUI, said third GUI prompting a user with a plurality of questions to formulate a post for electronic submission to at least one forum. The system further comprises programmatic instructions wherein execution of said programmatic instructions by a processor generates data representative of a third GUI, said third GUI prompting a user with a plurality of parameters to guide the formulation of a post for electronic submission to at least one forum.

Optionally, the system further comprises programmatic instructions wherein execution of said programmatic instructions by a processor generates data representative of a fourth GUI, said fourth GUI prompting the user to identify, or input information indicative of, at least one preferred forum within which to submit said post. The system further comprises programmatic instructions wherein execution of said programmatic instructions by a processor generates data representative of a fifth GUI, said fifth GUI providing links to at least one thread in said at least one preferred forum, wherein said at least one thread is responsive to said post. The link comprises a visual indicator. The visual indicator indicates access to said link is restricted. The system further comprises programmatic instructions wherein execution of said programmatic instructions by a processor generates data representative of a fourth GUI, said fourth GUI providing links to at least one forum user profile in said at least one preferred forum. Optionally, the system further comprises programmatic instructions for tracking a distribution of compensation to at least one of a forum or a forum member depending upon said thread responsive to said post.

In another embodiment, the present invention is directed to a server for hosting an electronic forum, comprising programmatic instructions wherein execution of said programmatic instructions by a processor a) receives a first forum interface call having a plurality of fields from a second server, b) conducts a search for content based on at least one of said fields, and c) communicates a response to said first forum interface call to said second server, wherein said response comprises a plurality of fields. Optionally, the server receives a second forum interface call from said second server, posts a query in response to said second forum interface call, and communicates threads posted in response to said query to said second server. Optionally, the server further comprises programmatic instructions wherein execution of said programmatic instructions by a processor generates data representative of a first GUI, said first GUI associating at least one visual indicator with said query. The visual indicator indicates to a member of said forum that said query originates from a non-member of said forum. The visual indicator indicates to a member of said forum that compensation may be provided to a member of said forum who provides an acceptable response to said query.

In another embodiment, the present invention is directed to a server for hosting an electronic forum, comprising programmatic instructions wherein execution of said programmatic instructions by a processor a) receives a forum interface call from a second server, b) posts a query in response to said forum interface call, and c) communicates threads posted in response to said query to said second server. The server further comprises programmatic instructions wherein execution of said programmatic instructions by a processor generates data representative of a first GUI, said first GUI associating at least one visual indicator with said query. The visual indicator indicates to a member of said forum at least one of a) that said query originates from a non-member of said forum or b) that compensation may be provided to a member of said forum who provides an acceptable response to said query.

### BRIEF DESCRIPTION OF THE DRAWINGS

These and other features and advantages of the present invention will be appreciated, as they become better understood by reference to the following detailed description when considered in connection with the accompanying drawings, wherein:

FIG. 1 illustrates one embodiment of a network of a plurality of forums and/or message boards;

FIG. 2a shows one embodiment of a communication network of the present invention, enabling non-members to syndicate queries and/or content to forums;

FIG. 2b is one embodiment of a graphical user interface that presents two options to a non-member user;

FIG. 3 is a flowchart depicting operational steps of the present invention, implemented when a non-member user requests to post a query to at least one forum;

FIG. 4 is a flowchart depicting operational steps of the present invention, implemented when a non-member user requests to post content to at least one forum; and

FIG. 5 illustrates one embodiment of a graphical user interface that allows a user to keep track of search results.

### DETAILED DESCRIPTION OF THE INVENTION

The present invention is directed towards systems and methods for enabling non-member, non-registered users of an online forum to syndicate queries and/or content onto the forum.

The present invention is also directed towards systems and methods for allowing non-member, non-registered users to syndicate queries and/or content onto the forum while ensuring that the integrity of character and community of the forum is maintained.

The present invention is also directed towards systems and methods for incentivizing forum-members to entertain queries from non-member users.

The present invention is also directed towards systems and methods for resolving user identifications of forum-members in case of username conflicts, particularly when at least two forums are merged.

The present invention is also directed toward a system that enables a user to a) post a question and, in return, receive the most relevant search results from a network of message board communities; or b) syndicate his question as a threaded discussion topic in the most relevant communities or community subforums.

The present invention is directed toward multiple embodiments. Reference will now be made in detail to specific embodiments of the invention. Language used in this specification should not be interpreted as a general disavowal of any one specific embodiment or used to limit the claims beyond the meaning of the terms used therein. Any alterations and further modifications in the described embodiments, and any further applications of the principles of the invention as described herein are contemplated as would normally occur to one skilled in the art to which the invention relates.

These and other objects of the present invention will now be described in the context of typical Internet/online forums, message boards, discussion boards, electronic discussion groups, discussion forums, bulletin boards or forums (hereinafter referred to generally as ‘forums’).

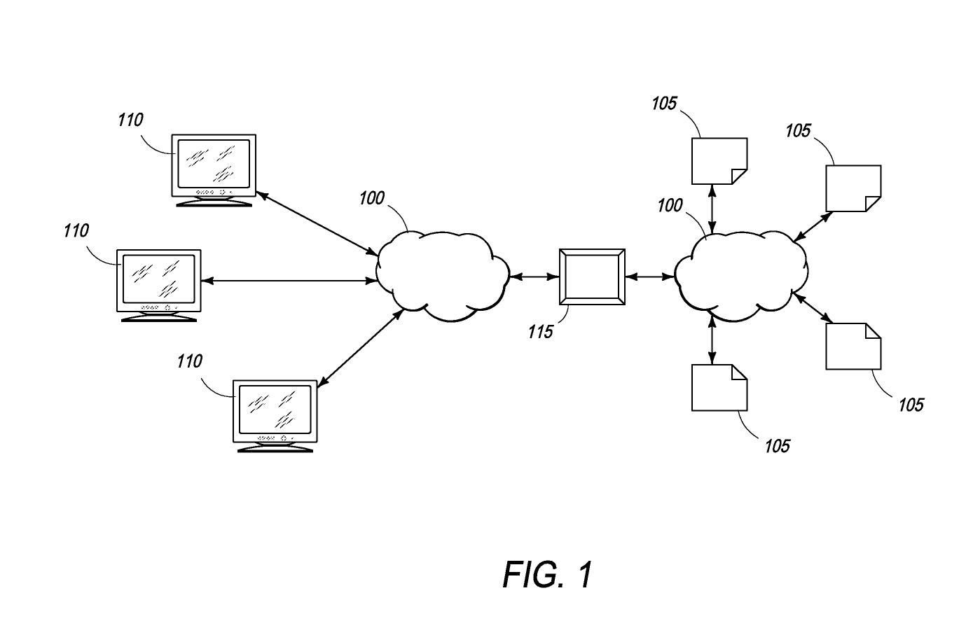

The systems and methods of the present invention enable non-members of an online/Internet forum to be able to interact with a plurality of forum networks while ensuring that the integrity, character and community-feel of the forum(s) are preserved. FIG. 1 illustrates one embodiment of a network of a plurality of forums and/or message boards, in which a plurality of groups of users (forum members) interact and socialize with each other, via the World Wide Web, by posting questions, answers, thoughts or any other form of expression as would be evident to one of ordinary skill in the art. Network 100 enables data communication between at least one forum 105 and a computing device operated by at least one user 110. Each forum is hosted by at least one server in data communication with network 100. Multiple forums can be hosted by either a single server or set of servers. Users' computing devices 110 interact with each other by communicating with the server, which hosts at least one forum, and submitting, retrieving, or otherwise interacting with the forum via interfaces displayed on the computing devices based upon programmatic instructions provided by the forum server(s).

Conventionally, each computing device communicates directly with individual servers that host one or more forums 105; however, in the present invention, network 100 enables data communication between user computing devices 110 and forums via a forum access server 115. When a user's computing device 110 accesses the forum access server 115, the forum access server 115 provides programmatic instructions that direct the user's computing device 110 to display a graphical user interface (not shown) which can be used by the user to syndicate content to, and obtain content from, a plurality of forums even if the user is not a current member of each of the forums.

One of ordinary skill in the art would appreciate that the features described in the present application are enabled by source code, compiled into an executable application, and executing on a computing device. The computing device, or computer, can be any type of device, including a laptop, personal computer, PDA, cell phone, server, or specialized communication device. Additionally, the programmatic code can be compiled into a single application, executing on a single computer, or distributed among several different computers operating locally or remotely to each other. Further, all data transmissions can occur wirelessly or through wired communications.

Persons of ordinary skill in the art would understand that users can become a member of each forum in the plurality of forums 105 in various ways. Conventionally, users may be required to register separately with each forum 105 requiring separate usernames, which may be unique, for every forum. Thus, only users that are registered members of a forum may access content on the forum, interact with people on the forum, and socialize with other members of that forum. Additionally, content and other community benefits, such as ability to ask queries, answer them, share news, facts, promotions and other expressions, of a forum are only available to registered members of that forum. Therefore, forum access is restricted to registered members only. Persons of ordinary skill in the art would appreciate that one of the key reasons for restricting forum interactions to only members is to preserve the integrity, community-feel and unique character of a forum that has been created, fostered and established by the members of that forum. In fact, it is this forum integrity that attracts the members to frequent and use the forum as a place to interact and socialize with like-minded people.

Therefore, a key challenge for making forums, and forum content, more accessible to non-members is to do so without destroying the forum's unique character. Typically, a forum's character is protected by members and administrators that monitor user interactions, place restrictions on poorly behaving members, and generally enforce rules to ensure people who add positive content to the forum are rewarded, or lauded, and those who present negative content to the forum are discouraged or punished. To do this, conventionally, people wishing to access, or provide, content need to become members and all non-member interactions are heavily restricted or prevented altogether.

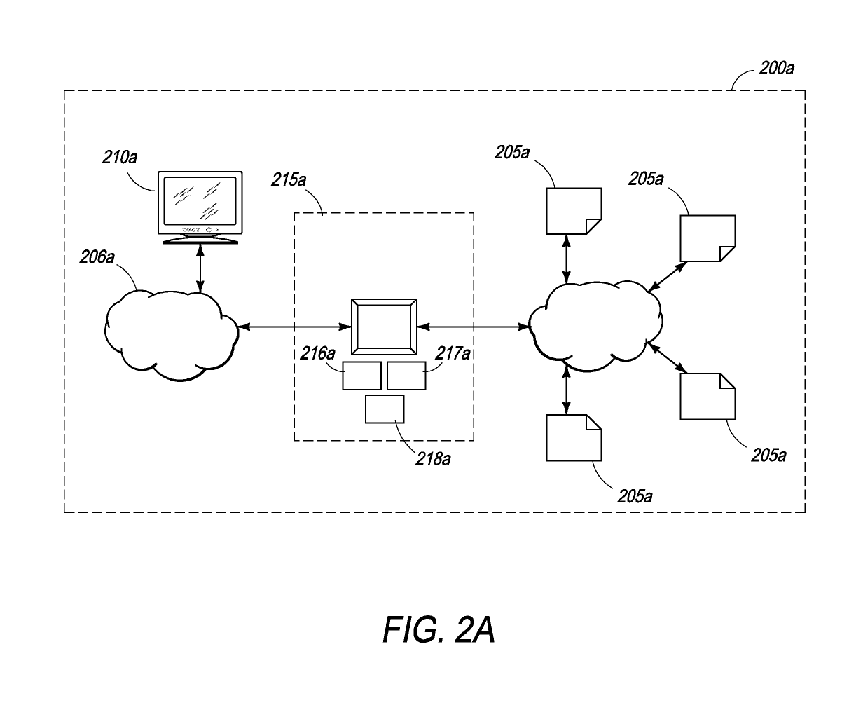

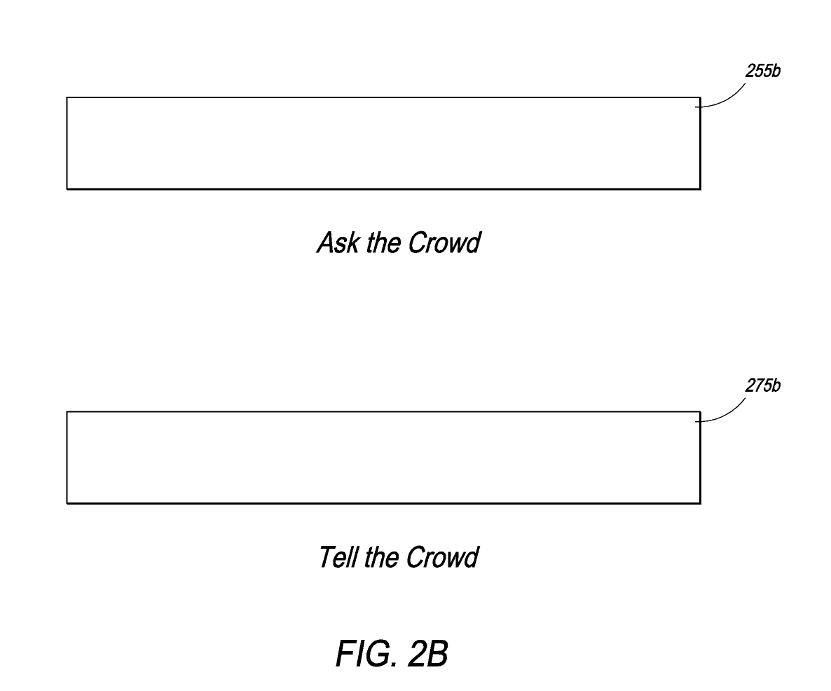

FIG. 2a shows one embodiment of a communication network of the present invention, enabling non-members to syndicate queries and/or content to forums. In one embodiment, via the communication network 200a of the present invention, non-member users may a) ‘syndicate queries, that is, query a plurality of forums and/or network of forums by posting questions to forum access server 215a, which will, in turn, syndicate the user query to appropriate forums 205a so that the user can receive meaningful answers to their queries and b) ‘syndicate content’, that is, provide, push or feed content to a relevant plurality of forums and/or network of forums. Thus, non-members are allowed to ‘Ask the Forum’ or ‘Ask the Crowd’ (syndicate queries) as well as ‘Tell the Forum’ or ‘Tell the Crowd’ (syndicate content).

In one embodiment, and by way of example only, communication network 200a comprises a plurality of forums 205a, each executing on one or more servers, and accessible via a forum access server 215a. Forum access server 215a can be accessed by a user using a computing device 210a, connected to communication network 200a via the Internet 206a. Computing device 210a can be used by a non-member user to access a plurality of forums and/or network of forums 205a through Internet 206a, via forum access server 215a. It should be appreciated that the forum access server could be an individual, separate standalone server that remotely communicates with the forum servers or could be a programmatic module that is embedded within, integrated into, or operating within the forum servers themselves and is used to field queries and syndicate content in a peer to peer manner.

In one embodiment, the non-member, via a computing device 210a accesses a forum access server 215a, residing at a remote location or as a network of co-located or remotely located forum access servers and accessible via a network connection to syndicate queries and/or content to the plurality of forums and/or network of forums 205a which are also accessible through the forum access server 215a. In other words this plurality of forums and/or network of forums 205a can be accessed by non-member users from a singular interface conveniently provided by forum access server(s) 215a.

In one embodiment, forum access server 215a provides a graphical user interface 250b, as shown in FIG. 2b, in the form of a webpage that can be viewed by a user on any computing device 210a which further comprises a web browser and a display source. The graphical user interface, and thus, the forum access server 215a, presents two options, shown as dialog boxes 255b and 257b in FIG. 2b, to a non-member user (a user who is not a registered member of at least one of the forums in the network of forums). In one embodiment, a user may wish to syndicate queries. For example, the graphical user interface 250b may present a first option 255b such as “Do you want to ask the Forums?” or “Ask the Crowd”. In another embodiment, a user may wish to syndicate content. For example, the graphical user interface 250b may present a second option 257b such as “Do you want to share knowledge with the Forums?” or “Tell the Crowd”.

The non-member user is then able to select the first and/or second options 255b and 257b, respectively. Depending upon the selection, the communication network 200a of the present invention enables the non-member user to syndicate queries and/or content to the plurality of forums 205a.

It is an express intent of the present invention to prevent the non-member user from compromising the integrity and character of the forums 205a while querying or sharing content with forums 205a using user computing device 210a. Thus, the communication system of the present invention further comprises at least one characterization engine. In one embodiment, a first characterization engine comprises a search engine 216a. In another embodiment, a second characterization engine comprises an intelligent prompt 217a. Both search engine 216a and intelligent prompt 217a are used to ensure that only worthy, relevant, appropriate, and/or unique questions and content are posted to forums 205a by non-members. The first and second characterization engines 216a, 217a are implemented as software programs that reside on, or in, the forum access server 215a.

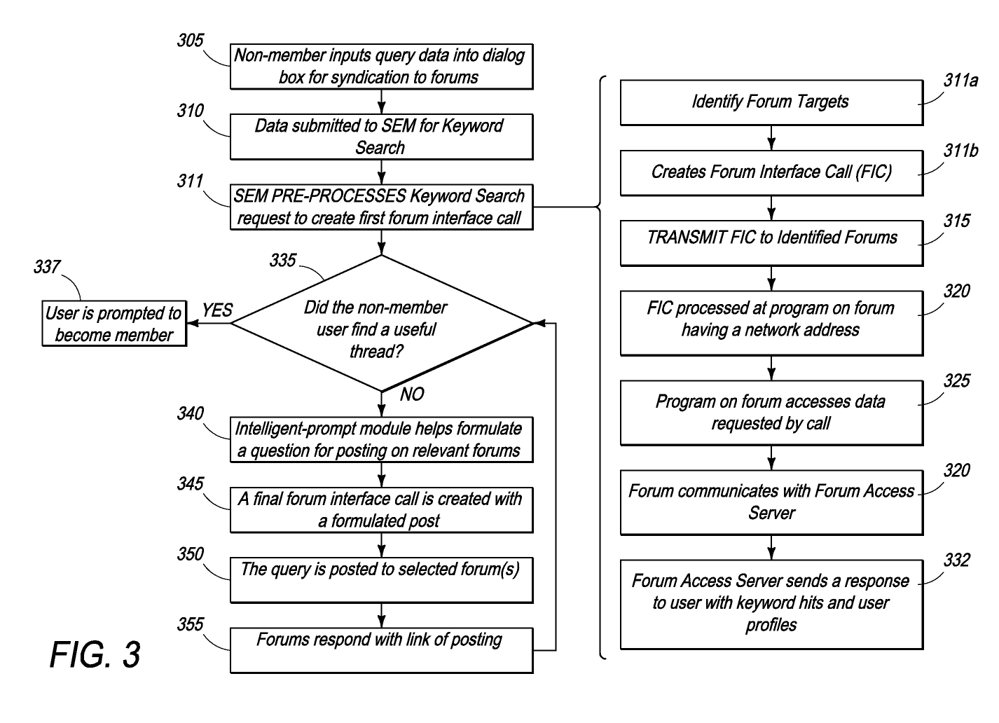

By way of example, suppose that non-member user “A” on computing device 210a opts to syndicate a query to forums 205a. Upon selection of the query syndication option, user A is guided through a series of logical steps, shown in the flowchart of FIG. 3.

FIG. 3 is a flowchart depicting operational steps of the present invention, implemented as a syndication search, when a non-member user requests to post a query to at least one forum. Referring now to FIG. 3, in step 305, a non-member user inputs data into a dialog box, shown as 255b in FIG. 2b, in order to post a query to the at least one forums. In step 310, the data received by the dialog box is submitted to the search engine module (SEM) in the forum access server.

In one embodiment, in step 311, the SEM pre-processes the search request. In one embodiment, the pre-processing step further includes identifying forum and/or user profile targets in step 311a. Optionally, the SEM may present a keyword search interface to the non-member user through which the user can input guidance data that would enable the forum access server to narrow in on relevant forums of interest to the non-user member. For example, the interface may ask the user a series of questions, including but not limited to asking the user: a) to confirm a recommended set of forum targets (created by the SEM through a keyword match to a forum database); b) if the user wants to add a forum (by showing a list of forums and asking the user to select at least one forum from that list); c) if the user is interested in a particular user name or profile; d) if the user would be willing to offer a bounty or reward for the answer, among other questions.

In one embodiment, the pre-processing includes the step of extracting keywords to create a forum interface call. For the SEM to initiate the search, the search should be formatted properly. Thus, in step 311b, the SEM further pre-processes the non-member user data input to create a forum interface call, which includes, in one example, via an API, the following formatted query:

TYPE: Query

KEYWORD 1: First keyword parsed out by the SEM

KEYWORD 2: Second keyword parsed out by the SEM

KEYWORD N: third through the nth keyword parsed out by the SEM—each one would have its own field.

PROFILE NAME 1: first profile name input by the user

PROFILE NAME 2: second profile name input by the user

PROFILE NAME N: third through the nth profile parsed out by the SEM—each one would have its own field.

Once the SEM formats a first forum interface call, it transmits, in step 315, the forum interface call to the identified forums (each forum is associated with a network address). When the formatted forum interface call is sent to the network address of at least one identified forum, a program at the address recognizes the call based on the format or type field, and in step 320, processes it. Forums would preferably integrate the program, which is an API that implements the standard interface call as described above, into its existing application suite executing on a server.

In step 325, the forum accesses the data requested at the forum network address by the call. In one embodiment, the program residing at the forum accesses the data by dynamically performing a keyword search. In another embodiment, the program at the forum accesses the data by pre-sorting threads based on keywords and matching the requested keywords with existing keyword categories and extracting threads listed therein. In yet another embodiment, the program at the forum accesses the data by dynamically accessing all threads, profile information, and other various data pieces associated with each user or profile name. It should be noted that the data can be accessed by using any one of or a combination of the above-mentioned methods.

In step 330, the forum then responds, via a complementary API, back to the forum access server. The response, in one embodiment, comprises, but is not limited to, the following fields:
TYPE: Query Response
THREAD 1: A link to the first identified thread.
THREAD 2: A link to the second identified thread.
THREAD N: A link to the Nth identified thread (where N can be any reasonable number).
PROFILE NAME 1: A link to a profile of a first user who participates in the thread.
PROFILE NAME 2: A link to a profile of a second user who participates in the thread.
PROFILE NAME N: A link to a profile of a Nth user who participates in the thread (where N can be any reasonable number).
FORUM PARAMETER 1: Willing to accept post from non-users
FORUM PARAMETER 2: An administrator-established requirement for receiving a post
FORUM PARAMETER 3: Characteristic related to thread 1.
FORUM PARAMETER 4: Characteristic related to thread 2.
FORUM PARAMETER N: Characteristic related to thread N.

It should be noted herein that the forum parameters are fields that administrators can establish in order to communicate guidelines for permitting non-users to query and/or mine information. Thus, these forum parameters allow each forum administrator to dynamically control whether, and to what extent, various posts can be fielded by a forum. For example, an administrator may want to prohibit new queries into a particular forum (e.g. if there are already too many posts for the day, content does not meet forum standard, etc.). Forum Parameter 1 can be set to “no”, which would prevent the SEM from sending a new post to that forum. Other manipulatable fields include, but are not limited to, whether only posts with payments associated therein can be posted, whether to retrieve answers to a post, whether a user must register, what format guideline to use in submitting a post, which content is restricted from a post, and the like. Thus, forum administrators have the real-time ability to control the invasiveness of the query syndication system of the present invention.

For example, if a query submitted to a forum via the interface call causes a search which results in a large number of threads which have been banned, highlighted as being explicit, or assigned any other characteristic by the forum administrator, the response to the interface call can include the characteristic designation (banned, explicit, etc.) in the Forum Parameter. When received by the forum access server, the server can parse the characteristic designation in the Forum Parameter field and inform the user of the characteristic designation prior to, or concurrent with, presenting the thread link.

In one embodiment, the SEM, using the forum access server, communicates to the user's computing device, in step 332, a response that a) lists a set of keyword hits on threads which, if the user clicks, he gets access to the threads and b) lists a set of links to user profiles again which, if the user clicks, he gets access to forum members who may be able to help answer the query.

After the fast search and thread/profile response return, in step 335, the user is prompted to see if the user was able to find a useful thread providing answer to his query. The prompt in one example is a simple question such as “did you find your answer?” For example, suppose a person inputted the following query: “How do I balance nitrate levels on a saltwater fish tank?” The system implements a general search of existing content on a plurality of forums. In the course of the search, relevant content, or threads, are identified from two forums: Fishtankforums.com and AquaticPlantCentral.com. The network addresses of those results are determined by the forum access server and presented, in the form of links in a graphical user interface, to the user. The user is prompted, in a graphical user interface, to view the identified results and then asked, within the same or subsequent graphical user interface, if the answers are relevant.

If the user responds with a ‘no’, the user is queried, via a graphical user interface, whether the user would like to ask the question directly to the communities. If the user responds with a ‘yes’, the system operating on the forum access server initiates an intelligent prompt module, which is described above with respect to FIG. 2. Alternatively, the system assumes the user would like to syndicate a query directly to the communities after answering ‘no’ above and, by default, initiates an intelligent prompt module. The intelligent prompt module prompts the user, in step 340, with a series of questions designed to formulate a question for actual posting as a thread in relevant forums. In one embodiment, the questions are formulated to guide the user to restrict or define his query according to the forum administrator defined parameters in the output call. In another embodiment, the user is first prompted, via a graphical user interface, to log-on or register an account. It should be appreciated that the graphical user interfaces presented to the user are generated by the forum access server communicating programmatic instructions to an application, such as a browser, operating in the computing device.

In one embodiment, the intelligent prompt module's questions are formulated from the initial ‘X’ keyword search (example: “Are you looking for ‘X’?”). The user is allowed to modify the prompted question (to add more details, etc.) and add tags to help focus the search in a particular area. The system also prompts the user to suggest a forum or community that is closest to the question he wants to ask. Additionally, optionally, or alternatively, the system provides a full list of forums or a selected most relevant list based on the keywords and tags. For example, meta-descriptions of all the forums, or only the most relevant forums, may be presented to the user, via a graphical user interface, as an aid to help the user decide which communities would best be able to answer the user's question.

Further optionally, the prompt questions are tailored based upon the Forum Parameter fields received from the response to the initial call. For example, if the Forum Parameter field indicates that the forum is not currently accepting posts, then the presented list of forums would be modified to shade out, or prevent a user from selecting, the forum which is not accepting posts. If the Forum Parameter field indicates that the forum will only accept a post if a bounty is associated with the post, then the presented list of forums would be modified to highlight, or indicate that, a specific forum requires a bounty, thereby empowering a user to select, or not select, the forum based on the bounty requirement. If the Forum Parameter field requires the user to register in order to post, then the presented list of forums would be modified to highlight, or indicate that, a specific forum requires registration. One of ordinary skill in the art would appreciate that any forum-established parameter for posting can be inserted in the Forum Parameter field and then used by the forum access server to intelligently inform the user of the requirements, extract required information from the user, or incorporate the requirements in the question prompts.

The intelligent module then causes a graphical user interface to be generated that prompts a user to create a detailed question with a descriptive title. Once the user fully formulates the question and selects a preferred set of forums to syndicate the question, in step 345, a call is formulated with a formulated post as follows:

TYPE: Post

USER INFORMATION 1: Profile name of the user

USER INFORMATION N: Other forum-requested information

BOUNTY: Y or N (user would offer a bounty)

AMOUNT: bounty amount

POST: A formulated and acceptable query post.

The identified forums receive the interface call containing the formulated post, process the call by extracting the relevant post field, and present the post to the forum members. That thread then gets posted, in step 350 to the selected forum(s). In step 355, once a query is posted, the forum responds back to the forum access server and provides a response to the call. The thread may be identified by the API software integrated into the forum software, which recognizes that the thread is a response to a posting associated with a prior forum interface call and thereby generates a response call, which may include the following parameters, for transmission back to, and parsing by, the forum access server:

TYPE: Post Response

FORUM POST RESPONSE 1: First administrator response to the formulated post.

FORUM POST RESPONSE N: Nth administrator response to the formulated post.

LINK to POST: Provides an active link to post on GUI.

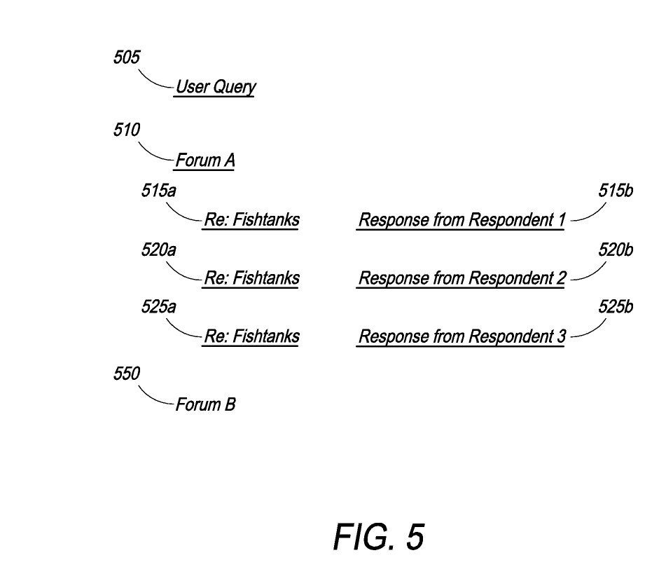

Thus, the forum response includes a link to the post on the user account page shown in the GUI of FIG. 5 and further described below.

The present invention also implements a plurality of additional features to ensure that the quality and character of forums is not undermined while enabling a symbiotic relationship between non-member users and forum members. For example, it is quite possible that the syndicated content and/or questions, by non-members, may be deemed too frivolous, intrusive, improper, or naïve to entertain and answer by forum members. In such cases the present invention allows for the content to be moved by the moderator to some other forum or location. If so, the user is automatically informed of this via a Forum Post Response field which is filled by forum administrators and may include guidelines on how to post in the future along with, for example, guidelines on why the content was moved, what would be accepted in the future and other instructions relevant in this context. In one embodiment, the question is moved to a general bin which may have, associated with it, higher incentives for the forum members for taking the time to answer them. In such a case, the Forum Post Response may also include a requirement for the bounty to be increased in order to access the post (in which case the post may be delayed until a subsequent call indicating that the user has increased the bounty is received).

Referring to FIG. 5, an exemplary graphical user interface depicting the various types of responses which the present invention can generate is shown. Again, it should be appreciated that, as with the other graphical user interfaces described herein, the graphical user interface is generated by the forum access server transmitting programmatic instructions to the user's computing device, which are used by the user's computing device, and particularly the browser, to generate links, textual descriptions, and/or graphical representations indicative of the search results.

Query link 505 is a link to the user's previously formulated query. The Forum A link 510 is a link to a description of Forum A and a log-in page and/or new account activation page for Forum A. Forum A Response link one 515a is a link to a response posted by a first member 515b in Forum A. Each link 515a, 515b can be clicked on to access the desired information, namely the response or profile of the first member. Forum A Response link two 520a is a link to a response posted by a second member 520b in Forum A. Each link 520a, 520b can be clicked on to access the desired information, namely the response or profile of the second member. Forum A Response link three 525a is a link to a response posted by a third member 525b in Forum A. Note that Forum A Response link three 525a is italicized, providing a visual indication that there is a defect, problem, restriction, or limitation associated with the response. The limitation could be a) the person responding to the query requests compensation, or additional compensation, for allowing a user to access his response, b) the forum requests compensation, or additional compensation, for allowing a user to access this third response, c) the forum administrator has banned the response or otherwise placed an indication that the response is disparaging or improper, or d) the forum administrator has banned the user or otherwise placed an indication that the user's query, or user himself, is not welcome in the forum. It should be appreciated that any visual indicator can be used, including bold, underline, different font sizes or styles, or different colors.

In one embodiment, a user is permitted to post queries, and access responses, for free. In another embodiment, a user is permitted to post queries for free, but access responses only after paying a form of compensation. In another embodiment, a user is permitted to post queries for free and access a pre-defined number of responses for free, after which the user must pay some form of compensation. In another embodiment, a user must pay to post a query and receive responses. The compensation can be any form of payment, including monetary payment by credit card, checking account, barter, reward program points, credits obtained by answering questions posed by other people, credits obtained by rating the answers of responders, or other forms of compensation. Payment can be effectuated using payment methods known to persons of ordinary skill in the art, with a user's account balance maintained by the forum access server and queried when attempting to access a response that a) requires payment to access or b) exceeds the number of free responses to which the user is entitled. If queried and the user's account balance is below the requisite compensation level, a visual indicator can be generated that indicates access to the response is restricted until the user provides more compensation.

In one embodiment, the system enables the creation, management, and accounting of a revenue share relationship between the entity hosting the forum access server and the entities hosting the forums themselves. Specifically, the system maintains a central accounting database which tracks a) each user's account balance (which may be in the form of benefits, points, credits, or actual monetary value), b) each user's actions which warrant deducting value from the user's account balances, such as posting queries or accessing responses, c) the forums to which the user has posted the query or from which the user is accessing a response, and d) the forum member which has provided the response being accessed by the user.

The present invention provides for a compensation sharing arrangement to occur between each of the entity hosting, owning, maintaining or operating the forum access server, the entity hosting, owning, maintaining or operating the forum, and the forum member providing answers to queries. Specifically, the compensation sharing arrangement can be effectuated by tracking the amount of compensation a user offers for an answer to a query, the percentage owed to the forum for posting the query, and the percentage owed to a forum member for providing an acceptable answer to the query. In one embodiment, where a user successfully posts a query and receives an acceptable answer (as determined by eliciting, and receiving, an electronic response from the user regarding his or her satisfaction), value is deducted from the user's account balance and assigned to the forum access server entity, forum entity, and/or forum member's account balances, thereby effectuating a form of revenue share. In another embodiment, the user's account balance is automatically deducted, even if the user has not proactively authorized the deduction, if the response meets a predefined threshold (such as length), a forum member rating threshold (such as being highly rated by other members), or by default after the passage of a certain amount of time.

Such a compensation sharing arrangement can be effectuated with advertising revenue, as well as user-specific accounts. In an advertising scenario, an entity responsible for the forum access server can sell advertising that is associated with a specific query response posted by a forum member. Where that advertising is actively shown, viewed, or clicked on, the forum member and forum itself may share in that revenue, as tracked by the forum access server or a third party advertising server.

The Forum B link 550 is a link to a description of Forum B and a log-in page and/or new account activation page for Forum B. The Forum B link 550 is italicized, indicating that the query was not posted, providing a visual indication that there is a defect, problem, restriction, or limitation associated with the user's query. The limitation could be any restriction, including, but not limited to, a) the forum administrator or forum members felt the query was inappropriate for the forum, b) the forum administrator or forum members felt the user should not be permitted to post queries because of possibly improper historical conduct, c) the user did not indicate a willingness to be a member of the forum or allow the forum to access the user's profile, d) the user did not agree to pay, or provide an indication of payment, for posting the query or receiving responses, as required by the forum, or e) the user or query exhibited some disregard or failure to adhere to any of the forum parameters presented in a response to the forum interface call. The user can address any of the aforementioned limitations by a) reformulating the query, b) requesting special permission to post directly from the forum administrator, c) indicating a willingness to be a forum member or directly sign up as a forum member, or d) providing payment or indicating a willingness to pay. It should be appreciated that, through these user query control functions, a forum can permit non-member users to access the forum knowledge base without diminishing the integrity of the forum.

Similarly, at the specific forums, it is preferred to have visual indicators associated with user queries, including icons, or different text sizes, colors, font or other visually discernible identifiers, to indicate to the forum members that such uniquely identified user queries have special attributes, such as a) replying to such identified queries may earn the respondents points, credits, or other benefits in their forum community, or a third party community or b) warnings that disparaging or improper remarks in response to these uniquely identified queries may result in the imposition of disincentives, such as bannings or point, credit, or other benefit reductions.

If the user responds with a ‘yes’, in step 337, the intelligent prompt engine (described above with respect to FIG. 2) prompts the user to become a forum member. In fact it is an object of the present invention to motivate and induce non-forum members to become forum members. To do so, a plurality of persuasive methods are implemented such as asking the non-forum member to become a registered member to be able to syndicate queries, formulate a more in-depth query syndication and/or to access the query/search results. In one embodiment, a non-forum member is optionally limited to only syndicate a certain number of queries and/or access a certain number of results until proper membership is created.

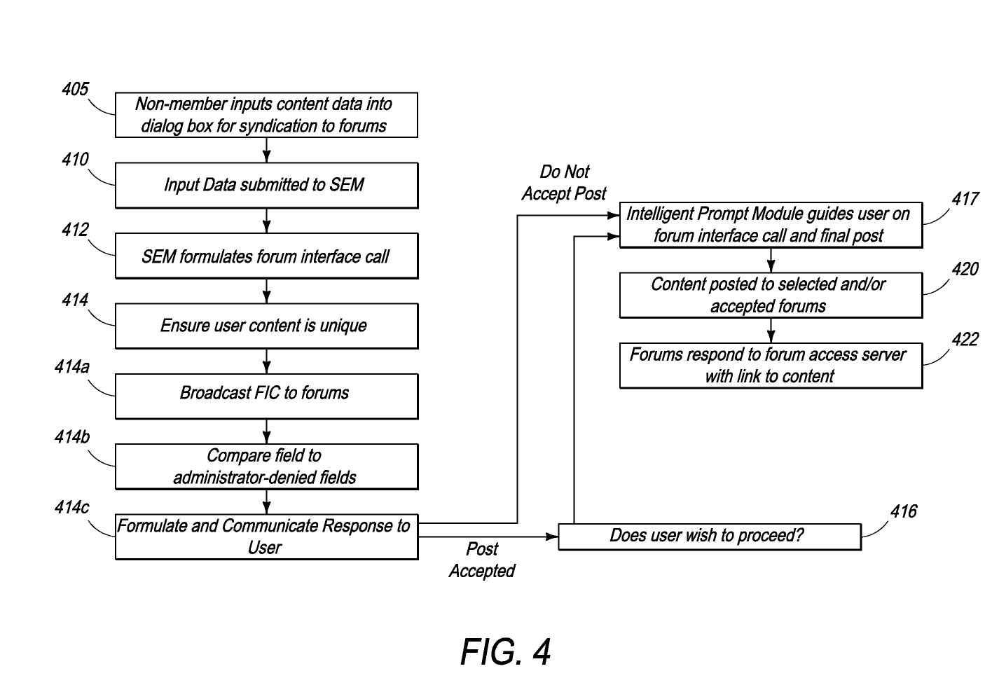

Referring back to FIG. 2a, and by way of example, suppose that non-member user “A” on computing device 210a opts to post content to forums 205a. Upon selection of the syndicate content option, user A is guided through a series of logical steps, shown in the flowchart of FIG. 4.

FIG. 4 is a flowchart depicting operational steps of the present invention, implemented when a non-member user requests to syndicate content to forums. In step 405, referring now to FIG. 4, a non-member user inputs data into a dialog box, shown as 257b in FIG. 2b, in order to syndicate content to the forums. The content input is then transmitted, in step 410, to the search engine module (SEM) in the forum access server. Based upon the initial input, in step 412, the forum access server, via the SEM, formulates a forum interface call. In one embodiment, the forum interface call includes the following parameters:

TYPE: Content Syndication

KEYWORD 1: Keywords extracted from the user content or input by the user

KEYWORD 2: Keywords extracted from the user content or input by the user

KEYWORD N: Keywords extracted from the user content or input by the user

PROFILE NAME 1: Profile name input by the user that he may be known by on any forum

PROFILE NAME 2: Second Profile name input by the user that he may be known by on any forum

PROFILE NAME N: Assume a maximum of 10 profile fields

USER NAME: Actual name of the user

CONTENT: User-formulated content.

In optional step 414, the search engine module of the present invention (described above with respect to FIG. 2), searches for the content (in the plurality of threads and content residing in the plurality of forums) to ensure that the content is unique and not already posted. Again this optional search functionality is performed to ensure that the integrity, quality and content of the forums is not undermined while enabling third-party creators of content or non-member users to share content. By way of example, suppose that user “A” intends to share breaking news from Mac World with the Mac Forum, the forum access server will first ensure that no one else has shared the news already on the network of forums. If, however, user A wishes to post the 1,000^{th} Harry Potter analysis, the consortium server will first determine how many “news items” already exist on that topic and limit the number of posts that may create a waste of forum space. If it is deemed that the “news item” is already posted and sufficiently covered on existing forums, the forum access server will advise the user that the post is denied.

In order to ensure that the content is unique, in step 414a, the forum interface call is broadcasted to each forum. Each forum then, in step 414b, compares fields from the received forum interface call to administrator-defined field. In one embodiment, fields are administrator-defined by using forum control software. In one embodiment, the control software is employed to allow an administrator, among other actions, to automatically ban content associated certain keywords or certain profiles, users, or real names.

Thereafter, in step 414c, the forum control software formulates a response based on the comparison and communicates the response to the user. For example, if a representative set of keywords in the interface call match any of the monitored keywords, the forum control software will formulate a response that denies the call request for syndication, which is communicated to the user in step 414c, in the form of a “Do Not Accept” response.

If a “Do not Accept” response is issued, in step 417, the intelligent prompt module provides guidance as to how to appropriately post content to relevant forum(s) by providing the user with a list of forum parameter queries. This helps the user create a final forum interface call for broadcasting content, which may include the following parameters:

TYPE: Content Syndication

KEYWORD 1: Keywords extracted from the user content or input by the user

KEYWORD 2: Keywords extracted from the user content or input by the user

KEYWORD N: Keywords extracted from the user content or input by the user

PROFILE NAME 1: Profile name input by the user that he may be known by on any forum

PROFILE NAME 2: Second Profile name input by the user that he may be known by on any forum

PROFILE NAME N: Assume a maximum of 10 profile fields

USER NAME: Actual name of the user

CONTENT: Formulated content.

If in step 414b, it is determined that the post is not prohibited, the in step 414c, the forum control software confirms to the user, in step 414c, that the content will be posted. Further, the forum control software also communicates to the user any special treatment or considerations that may pertain to the post. Thus, in one embodiment, the forum control software can establish a set of parameters for how certain posts will be treated.

If it is determined that the content in the forum interface call is unique, the intelligent prompt module (described above with respect to FIG. 2) asks the user, in step 416, if the user wishes to proceed with the content post. If it is determined that certain posts or content may need special treatment or considerations, the intelligent prompt module may optionally help the user conform the post to forum parameters, as described in step 417. Optionally, the user is provided with a list from which to select forums to post content. In step 420, content is posted to the forum(s) that the user selects.

In one embodiment, users who syndicate queries and/or content to forums keep track of their search results as well as posted content through a ‘My Account’ GUI (Graphical User Interface), which in one embodiment, is a web page on the forum access server. Thus, users log on to their account page and items such as view historical searches, links to the responsive posts, links to unread posts, links to user profiles. Thus, in step 422, once content is posted, the forum responds back to the forum access server and provides a response to the call which may include the following parameters for parsing by the forum access server:

TYPE: Content Syndication

LINK to POST: Provides an active link to post on GUI.

In one embodiment of the system of the present invention, a user may be assigned a single/unified username and password combination that can be used to access the plurality of forums that form at least part of the accessible content of the forum access server via the graphical user interface.

Persons of ordinary skill in the art would appreciate that forums are unique communities which need to be treated carefully. Abusing forum members, wasting their time, or diluting the quality of the content therein can cause forum members to flee. Therefore, it is another objective of the present invention to give forum members something in exchange for having the patience to handle the non-members who are mostly new to the forum(s) as well as incentivize forum members to answer queries posted by non-members.

Accordingly, referring back to FIG. 2a, the communication network 200a of the present invention further comprises an incentives module 218a. The incentives module 218a is implemented as a software program that resides at the forum access server 215a and deploys one or a plurality of incentive schemes or frameworks.

For example, and by way of example only, one such incentive scheme may award the forum members points or virtual credits for answering questions accurately and/or to the satisfaction of the non-member user on computing device 210a who asked the question. Incentives may also be based on the quality of the response.

Suppose a non-member user A posts a question via his or her computing device 210a and receives an answer. Thereafter, when the user logs onto their “My Account” page using computing device 210a, the non-member is prompted to comment on characteristics of the answer, such as the quality, the helpfulness, relevance, etc. Therefore, if the user 210a is satisfied with the response, he gives thumbs-up or, say, a gold star (or some other form of positive recognition) to the answering forum member. The more such credits the forum member gets, the more benefits he may get (goods, cool avatars, special forum treatment, user spotlights, possibly tied in with some other points system, other forms of barter). Alternatively and/or additionally forum members may also get real money from the non-member 210a who may be required to pay for an appropriate answer.

In another embodiment, reviews benefits, and/or incentives can be communicated using a separate interface call. Thus, the forum access server formulates a call as follows:

USER: User name

PROFILE NAME: Name of the person being reviewed by the user

BOUNTY: Y OR N

AMOUNT: Amount of the bounty

TRANSFER: Details on how the bounty is being transferred.

To further aid incentivization and tolerance of non-members by forum members, the system 200a of the present invention, in one embodiment, via the forum control software described above with respect to FIG. 4, differentiates the threads posted by non-members 210a by executing one or a plurality of schemes. For example, the threads posted by non-members 210a are presented in the forum(s) 205a in a color different from the one used to present threads of forum members. Other schemes comprise differentiators such as font-size, highlighters or any other form of distinction that would be evident to persons of ordinary skill in the art.

Differentiation of threads from non-members enables forum administrators/moderators and members to clearly and quickly know that the posted thread is from a non-member and, therefore, a) members should be nicer (not nearly as obnoxious as normal) and b) responses have the possibility of getting some reward. Thus, the present invention lays emphasis on the need to communicate to forum members to be nice to newbies and answer their questions. The present invention also lays emphasis on informing the forum moderator that he/she should treat the non-member with a bit more patience. Content syndicated by non-members may also be similarly differentiated from other posts/threads of forum members.

In one embodiment, to incentivize answers from forum members and ensure that non-member users do not post frivolous questions, the present invention requires the non-member user to pay for the right to ask a question (either in credits or real money). The non-member user puts those credits/money into an escrow account upon asking the question (the system automatically places the money/credits into escrow). Once the question is satisfactorily answered, the non-member user releases the money/credits. If he does not, the forum member can rate the non-member user and let the forum know that he may not live up to his promises. If the non-member user is unhappy, he can give an assessment of the quality of the answer received from a forum member and why it did, or did not, help him.

One of ordinary skill in the art would appreciate that forum members tend to be very attached to their user names. A user name is how a person is known or identified within the community and is the basis of a great deal of reputation investment. Therefore, the present invention ensures that the user names are treated with great care and that these are preserved in scenarios when forums are merged or become part of a larger consortium. In one embodiment, to resolve user identifications (IDs), all user IDs are first aggregated into a single table. Similar user IDs are then differentiated by adding differentiating elements. Examples of such differentiating elements comprises adding a prefix, such as when there are two Smiths, adding the forum name to the beginning of one Smith; a suffix; a differentiating color or any other differentiating element that would be evident to persons of ordinary skill in the art.

We claim:

1. A system for mediating an electronic communication between a forum having members and a non-member of said forum, comprising a server having programmatic instructions wherein execution of said programmatic instructions by a processor a) generates data representative of a first GUI, said first GUI prompting a user of said computing device to input a query, b) receives data representative of said query, c) parses said data representative of said query and uses said parsed data to create a forum interface call, d) transmits said forum interface call to a plurality of remotely located servers through a network, wherein at least some of said servers hosts at least one forum, e) in response to said transmission of forum interface calls, receives responses responsive to said query, and f) generates data representative of a second GUI, said second GUI providing a user of said computing device electronic access to said responses.

2. The system of claim 1 wherein said interface call includes a plurality of fields and wherein at least one of said fields is a type, keyword, or profile field.

3. The system of claim 1 wherein the parsing of said data representative of the query generates a plurality of keywords and wherein at least one of said keywords is input into a field of said interface call.

4. The system of claim 1 wherein the response responsive to said query includes a plurality of fields and wherein at least one of said fields identifies a network address where a query response is located.

5. The system of claim 1 wherein the response responsive to said query includes a plurality of fields and wherein said plurality of fields include at least one of a link to an identity of a respondent, a link to a respondent's response, or a parameter defining how queries may be inputted into, or extracted from, a forum.

6. The system of claim 1 further comprising programmatic instructions wherein execution of said programmatic instructions by a processor generates data representative of a third GUI, said third GUI prompting a user with a plurality of questions to formulate a post for electronic submission to at least one forum.

7. The system of claim 1 further comprising programmatic instructions wherein execution of said programmatic instructions by a processor generates data representative of a third GUI, said third GUI prompting a user with a plurality of parameters to guide the formulation of a post for electronic submission to at least one forum.

8. The system of claim 6 further comprising programmatic instructions wherein execution of said programmatic instructions by a processor generates data representative of a fourth GUI, said fourth GUI prompting the user to identify, or input information indicative of, at least one preferred forum within which to submit said post.

9. The system of claim 8 further comprising programmatic instructions wherein execution of said programmatic instructions by a processor generates data representative of a fifth GUI, said fifth GUI providing links to at least one thread in said at least one preferred forum, wherein said at least one thread is responsive to said post.

10. The system of claim 9 wherein said link comprises a visual indicator and wherein said visual indicator indicates access to said link is restricted.

11. The system of claim 9 wherein said system further comprises programmatic instructions for tracking a distribution of compensation to at least one of a forum or a forum member depending upon said thread responsive to said post.

12. The system of claim 8 further comprising programmatic instructions wherein execution of said programmatic instructions by a processor generates data representative of a fifth GUI, said fifth GUI providing links to at least one forum user profile in said at least one preferred forum.

13. A server for hosting an electronic forum, comprising programmatic instructions wherein execution of said programmatic instructions by a processor a) receives a first forum interface call having a plurality of fields from a second server, b) conducts a search for content based on at least one of said fields, and c) communicates a response to said first forum interface call to said second server, wherein said response comprises a plurality of fields.

14. The server of claim 13 wherein execution of said programmatic instructions by a processor a) receives a second forum interface call from said second server, b) posts a query in response to said second forum interface call, and c) communicates threads posted in response to said query to said second server.

15. The server of claim 14 further comprising programmatic instructions wherein execution of said programmatic instructions by a processor generates data representative of a first GUI, said first GUI associating at least one visual indicator with said query.

16. The server of claim 15 wherein said visual indicator indicates to a member of said forum that said query originates from a non-member of said forum.

17. The server of claim 15 wherein said visual indicator indicates to a member of said forum that compensation may be provided to a member of said forum who provides an acceptable response to said query.

18. A server for hosting an electronic forum, comprising programmatic instructions wherein execution of said programmatic instructions by a processor a) receives a forum interface call from a second server, b) posts a query in response to said forum interface call, and c) communicates threads posted in response to said query to said second server.

19. The server of claim 18 further comprising programmatic instructions wherein execution of said programmatic instructions by a processor generates data representative of a first GUI, said first GUI associating at least one visual indicator with said query.

20. The server of claim 19 wherein said visual indicator indicates to a member of said forum at least one of a) that said query originates from a non-member of said forum or b) that compensation may be provided to a member of said forum who provides an acceptable response to said query.
